(19) United States
(12) Patent Application Publication
(10) Pub. No.: US 2016/0313145 A1
(43) Pub. Date: Oct. 27, 2016

(54) Reflective Optical Sensor Element

(71) Applicant: NGK INSULATORS, LTD., Aichi-prefecture (JP)

(72) Inventors: Jungo Kondo, Miyoshi-city (JP); Shoichiro Yamaguchi, Ichinomiya-city (JP); Tetsuya Ejiri, Kasugai-city (JP); Keiichiro Asai, Nagoya-city (JP); Naotake Okada, Anjo-city (JP)

(73) Assignee: NGK INSULATORS, LTD., Aichi-prefecture (JP)

(21) Appl. No.: 15/165,107

(22) Filed: May 26, 2016

Related U.S. Application Data
(63) Continuation of application No. PCT/JP2014/080579, filed on Nov. 19, 2014.

(30) Foreign Application Priority Data
Nov. 27, 2013 (JP) 2013-244917

(51) Int. Cl. G01D 5/30; G01L 1/24; G02B 6/124; G01K 11/32

(52) U.S. Cl. CPC G01D 5/30; G01K 11/3206; G01L 1/246; G02B 6/124; G02B 2006/12097

(57) ABSTRACT

It is provided a reflective optical sensor device including a support substrate; an optical material layer disposed over said support substrate, said optical material layer having a thickness of 0.5 μm or larger and 3.0 μm or smaller; a ridge optical waveguide having an incident face to which a light from a semiconductor laser is incident and an emitting face for emitting an emission light with a desired wavelength; a Bragg grating with convexes and concaves formed within said ridge optical waveguide; and a propagating portion disposed between said incident face and said Bragg grating. The reflective optical sensor device satisfies relationships represented by formulas (1) to (3) below.

0.8 nm≦Δλ_{G}≦6.0 nm (1)

20 nm≦td≦250 nm (2)

nb≧1.8 (3)

(Δλ_{G} in the formula (1) is a full width at half maximum of a peak of a Bragg reflectivity; td in the formula (2) is a depth of each of convexes and concaves forming the Bragg grating; and nb in the formula (3) is a refractive index of a material forming the Bragg grating.)

### TECHNICAL FIELD

The present invention relates to reflective optical sensor devices.

### BACKGROUND ART

With the progress in sensor networks, systems with a fiber Bragg grating (FBG) have been increasingly developed (see Non-Patent Document 1 and Non-Patent Document 2). In such systems, optical fibers are installed to run through structures, such as buildings or bridges, whereby the FBG is used to measure the temperature and strain of the structure.

An FBG sensor can detect a change in the temperature or strain as a change in the wavelength of light. When a light beam enters an FBG, a segment of the FBG with a periodic variation in the refractive index reflects light with a Bragg wavelength (Δλ_{G}) represented by formula (1) below, while transmitting all others.

λ_{G}=2n_{eff}Λ (1)

where neff is the effective refractive index, and Λ is the grating period.

When the FBG experiences a change in temperature or a strain, it affects both the effective refractive index n_{eff} and the grating period Λ of the FBG, and as a result, the reflection wavelength is shifted depending on such a change. Therefore, temperature and strain sensors using the FBG are designed to sense the change in temperature and the strain by monitoring the wavelength of light reflected from the FBG.

For example, when the temperature sensor detects a change in the temperature, the Bragg wavelength can be represented as follows.

$$\begin{matrix}\frac{\partial {λ}_{G}}{\partial T} = \frac{\partial {λ}_{G}}{\partial {n}_{eff}} \frac{\partial {n}_{eff}}{\partial T} + \frac{\partial {λ}_{G}}{\partial Λ} \frac{\partial Λ}{\partial T} \\ = 2 {n}_{eff} Λ ( \frac{\partial {n}_{eff}}{\partial T} \cdot \frac{1}{{n}_{eff}} + \frac{\partial Λ}{\partial T} \cdot \frac{1}{Λ} )\end{matrix} \qquad ( 2 )$$

Component of Refractive Index Corresponding to a Change in the Temperature

$$\frac{\partial {n}_{eff}}{\partial T} \cdot \frac{1}{{n}_{eff}} = {α}_{n} \qquad ( 3 )$$

Component Corresponding to a Periodic Variation Due to Thermal Expansion

$$\frac{\partial Λ}{\partial T} \cdot \frac{1}{Λ} = {α}_{Λ} \qquad ( 4 )$$

This sensor has a thermal sensitivity Δλ_{G}=ΔT of about 9.5 pm/° C. when a Bragg wavelength is 1.55 μm. Correcting the influence by the strain requires a mounting structure with no strain applied or a mounting structure that compensates for the strain is required.

On the other hand, in the use of the strain sensor, a change in the Bragg wavelength due to the strain can be represented by formula (5) below.

$$\begin{matrix}{Δλ}_{G} = 2 {n}_{eff} Δ Λ + 2 ΛΔ {n}_{eff} & ( 5 ) \\ \frac{{Δλ}_{G}}{{λ}_{G}} = \frac{ΔΛ}{Λ} + \frac{Δ {n}_{eff}}{{n}_{eff}} & ( 6 )\end{matrix}$$

Component Corresponding to a Change in Period Due to Strain

$$\frac{ΔΛ}{Λ} = {ɛ}_{z} \qquad ( 7 )$$

Component Corresponding to a Change in Refractive Index Due to Strain

$$\frac{Δ {n}_{eff}}{{n}_{eff}} = - {p}_{e} \cdot {ɛ}_{z} \qquad ( 8 )$$

In this case, when the Bragg wavelength is 1.55 μm, a strain sensitivity of Δλ_{G}/ε_{z}=λ_{G} (1−Pe) is about 1.2 pm/με.

The temperature sensor and the strain sensor need to correct the influence by the strain and the temperature, respectively. In this aspect, the temperature sensor is mounted in such a manner as not to cause any strain in the FBG, or to compensate for the strain, thereby resolving the influence. For the strain sensor, in order to correct the influence of the temperature, an FBG is bonded to a dummy member (made of the same material as a specimen) with no strain, and a change in wavelength due to the influence of the temperature is subtracted from a detected value obtained by the strain sensor.

### CITATION LIST

### Non-Patent Documents

[Non-Patent Document 1] Isamu Nemoto et al., “FBG sensor”, KYOWA Engineering News No. 533, December 2005, pp. 4109-4114
[Non-Patent Document 2] National Instruments, Website release, Issue date: Sep. 20, 2012, |1 Ratings| 3.00 out of 5

### Patent Document

[Patent Document 1] Japanese Unexamined Patent Application Publication No. 2007-293215A

### SUMMARY OF INVENTION

However, the conventional FBG sensor has limitations in terms of its sensitivity to the heat and strain. Thus, an FBG sensor is required to have a structure that can exhibit higher sensitivity.

It is an object of the present invention to provide a reflective optical sensor device for the FBG sensor that can improve its sensitivity to changes in environment, such as heat and strain.

A reflective optical sensor device according to the present invention comprises:

a support substrate;

an optical material layer provided over the support substrate, the optical material layer having a thickness of 0.5 μm or larger and 3.0 μm or smaller;

a ridge optical waveguide having an incident face to which a light from a semiconductor laser is incident and an emitting face for emitting an emitted light with a desired wavelength;

a Bragg grating with convexes and concaves formed within the ridge optical waveguide; and

a propagating portion disposed between the incident face and the Bragg grating,

wherein the reflective optical sensor device satisfies the relationships represented by the following formulas (1) to (3).

0.8 nm≦Δλ_{G}≦6.0 nm (1)

20 nm≦td≦250 nm (2)

nb≧1.8 (3)

(where Δλ_{G} in the formula (1) is a full width at half maximum of a peak of a Bragg reflectivity;

td in the formula (2) is a depth of each of the convexes and concaves forming the Bragg grating; and

nb in the formula (3) is a refractive index of a material forming the Bragg grating.)

The arrangement according to the present invention is applied to the FBG by using the extremely thin optical material layer made of a high-refractive-index material with a refractive index of 1.8 or higher to create therein the convexes and concaves with a specific depth, thereby forming the grating.

With this arrangement, when a change in temperature or strain occurs in a grating portion, a change in its Bragg reflection wavelength can be increased to enhance the sensitivity of the FBG, compared to a conventional FBG. Furthermore, the high reflectivity can be attained with a short grating length, which enables the miniaturized sensor.

### BRIEF DESCRIPTION OF THE DRAWINGS

FIG. 1 is a front view schematically showing a reflective optical sensor device 9.

FIG. 2 is a perspective view showing the reflective optical sensor device.

FIG. 3 is a schematic cross-sectional view of the device shown in FIG. 1.

FIG. 4 is a schematic cross-sectional view of a reflective optical sensor device according to another embodiment.

FIG. 5 is the results of reflection characteristics for the grating lengths of 30 to 70 μm.

FIG. 6 shows the results of the reflectivity and the full width at half maximum of the reflected light peak for each of the grating lengths of 10 μm to 1000 μm.

FIG. 7 shows the results of the reflectivity and the full width at half maximum for the grating lengths of 100 μm or more in each of the grating-groove depths of 200 nm and 350 nm.

FIG. 8 shows the results of the reflectivity and the full width at half maximum for the grating lengths of 50 to 1000 μm in each of the grating-groove depths of 20, 40, and 60 nm.

FIG. 9 shows the results of the reflectivity and the full width at half maximum at the grating length of 100 μm when changing the grating-groove depth from 20 to 100 nm.

FIG. 10 is a block diagram showing an example of the structure of an FBG sensor.

FIG. 11 is the result of calculation of the effective refractive index (equivalent refractive index) in a transverse mode and fundamental mode of the optical waveguide when changing a depth Tr of a ridge groove from 0.1 μm to 1.2 μm.

FIG. 12 is the result of calculation of spot sizes in the horizontal direction and the vertical direction, respectively, in the fundamental mode of the optical waveguide calculated as shown in FIG. 11.

### MODES FOR CARRYING OUT THE INVENTION

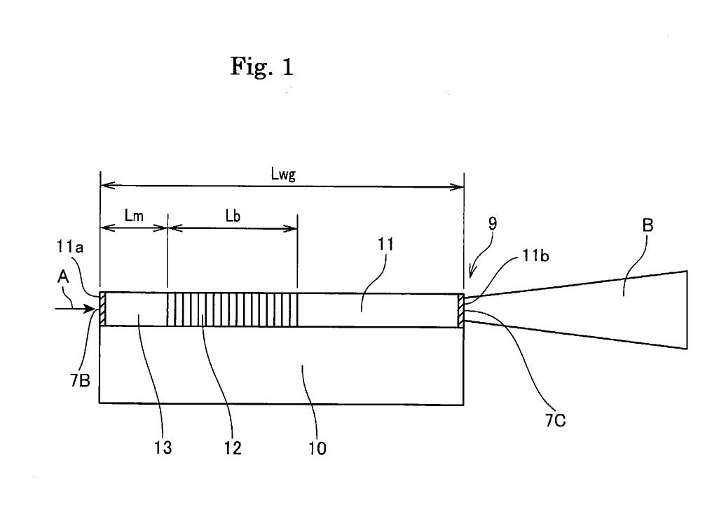

As shown in FIGS. 1 to 3, a reflective optical sensor device 9 is provided with an optical material layer 11 that has an incident face 11a to which a semiconductor laser light A is incident as well as an emitting face 11b from which an emitted light B with a desired wavelength exits. C indicates reflected light. A Bragg grating 12 is formed within an optical waveguide 18 formed in the optical material layer 11. A propagating portion 13 not having any grating is provided between the incident face 11a of the optical material layer 11 and the Bragg grating 12. A non-reflective film 7B is provided on the incident face side of the optical material layer 11, while a non-reflective film 7C is provided on the emitting face side of the optical material layer 11. The optical waveguide 18 is a ridge optical waveguide provided on a substrate 10. The optical waveguide 18 may be formed at the same surface side as the Bragg grating 12, or alternatively formed at the opposite surface to the Bragg grating.

The reflectivity of each of the non-reflective films 7B and 7C may be smaller than the grating reflectivity, and is preferably 0.1% or less. However, if the reflectivity of the end surface of the optical material layer is smaller than the grating reflectivity, the non-reflective layer is not required.

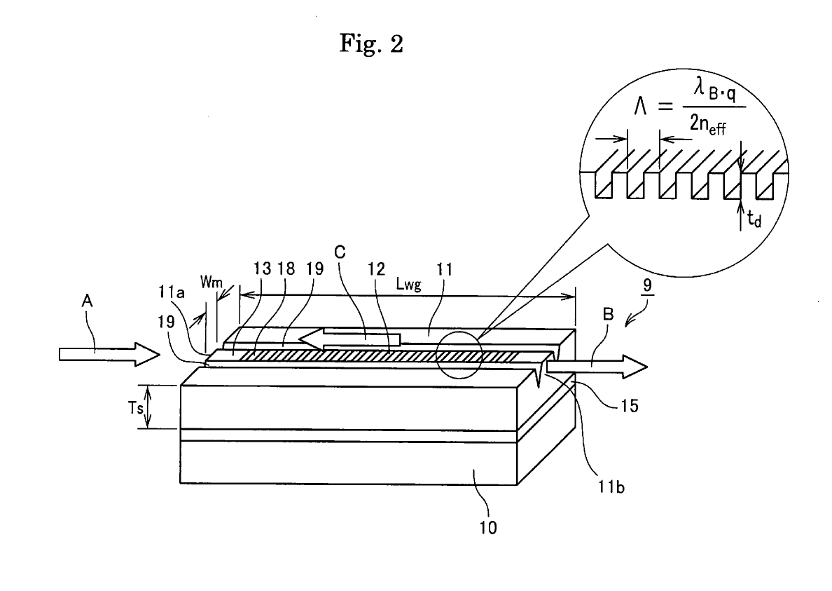

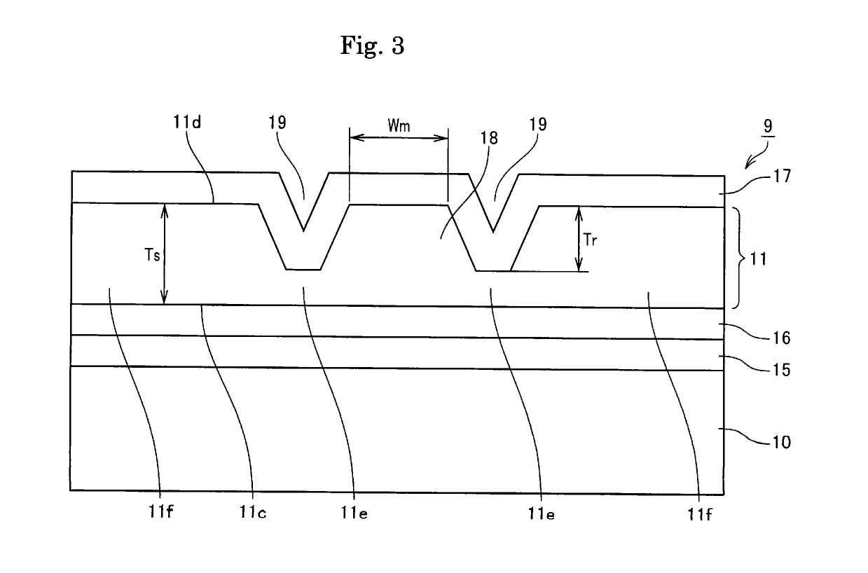

As illustrated in FIGS. 2 and 3, in this embodiment, the optical material layer 11 is formed over the support substrate 10 via an adhesive layer 15 and a lower buffer layer 16. An upper buffer layer 17 is formed over the optical material layer 11. For example, a pair of ridge grooves 19 is formed in the optical material layer 11, and the ridge optical waveguide 18 is formed between the ridge grooves.

In this embodiment, the ridge groove is not completely cut to the bottom. That is, a thin portion 11e is formed under each of the ridge grooves 19. An extended portion 11f is formed at each of the outer sides of the thin portion 11e. In the invention, the ridge groove 19 is not formed to completely cut the optical material layer 11 and to leave the thin portion 11e between the bottom surface of the ridge groove 19 and the buffer layer.

In this case, the Bragg grating may be formed at a flat surface 11c or at a surface 11d. To reduce variations in the shape of the Bragg grating and the ridge groove, the Bragg grating is preferably formed on the surface 11c, thereby positioning the ridge grooves 19 on the opposite side of the substrate to the Bragg grating.

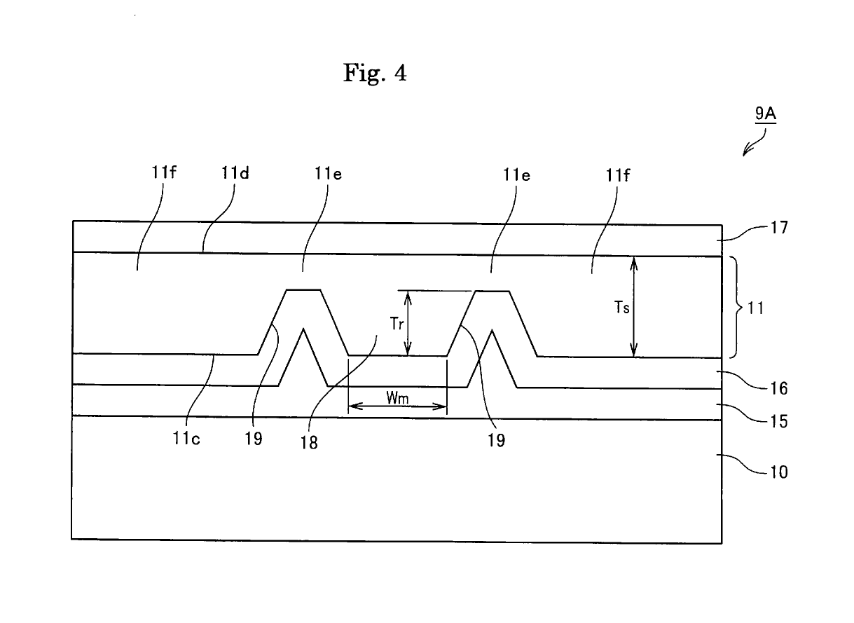

In an element 9A illustrated in FIG. 4, the optical material layer 11 is formed over the substrate 10 via the adhesive layer 15 and the lower buffer layer 16, and the upper buffer layer 17 is formed over the optical material layer 11. For example, the pair of ridge grooves 19 is formed on the support substrate 10 side in the optical material layer 11, and the ridge optical waveguide 18 is formed between the adjacent ridge grooves 19. In this case, the Bragg grating may be formed on the flat surface 11d side or at the surface 11c with the ridge grooves formed thereat. To reduce variations in the shape of the Bragg grating and the ridge groove, the Bragg grating is preferably formed on the flat surface 11d side, thereby positioning the ridge grooves 19 on the opposite side of the substrate to the Bragg grating. Further, the upper buffer layer 17 may not be formed. In this case, an air layer can be in direct contact with the grating. With this arrangement, the presence and absence of the grating-grooves can increase a difference in refractive index between the layers with and without the grating-grooves, thereby increasing the reflectivity in a short grating length.

Such a ridge optical waveguide can weaken the trapping of light therein, compared to a structure in which ridge grooves are completely cut to the bottom (without any thin portion 11e and with the extended portion 11f). Thus, even if the shape of a light spot becomes large, the transverse mode or multi-mode is less likely to be excited, enabling the excitation of the fundamental mode. Because of this, the influence of the multi-mode is suppressed, whereby the sensor with less noise can be achieved.

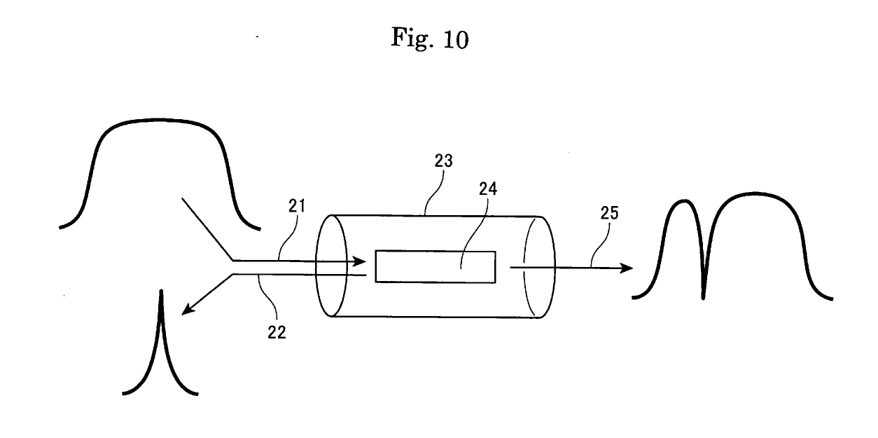

An FBG sensor is designed to detect a change in the temperature or strain as a change in the wavelength of light. FIG. 10 shows a general arrangement.

First, a reflective optical sensor device 24 of the invention is installed in a sensor main body 23. Broadband light 21 is incident on the reflective optical sensor device 24. On the incidence side, a reflected light 22 at the Bragg wavelength is reflected, while on the emission side, an emitted light 25 at the Bragg wavelength is emitted. At this time, a segment of the FBG with a periodic variation in the refractive index reflects light with the Bragg wavelength (λ_{G}) represented by the formula (1) described above, and transmits light with all other wavelengths. The wavelength of the reflected light changes depending on the temperature, strain, and the like of an object to be measured. The change in the wavelength can be used to sense a change in environment, such as the temperature and the strain, of the object to be measured.

The above-mentioned conditions in the invention will be described in detail below.

The invention is based on the assumption that the optical material layer is extremely thin, specifically with a thickness Ts (see FIGS. 3 and 4) of not less than 0.5 μm nor more than 3.0 μm, and thus has the strong light trapping capability.

In addition, the refractive index nb of the material of the optical waveguide is 1.8 or more. Thus, a change in the refractive index depending on the temperature can be increased, thereby enhancing the sensitivity of the reflective optical sensor device as a temperature sensor. Further, a change in the refractive index due to the stress represented by the formula (8) can be increased, thereby enhancing the sensitivity of the reflective optical sensor device as a humidity sensor. From this viewpoint, nb is further preferably 1.9 or more. The upper limit of nb is not specifically limited. However, any excessive refractive index nb leads to an excessively small grating pitch in design, making it difficult to form the grating. Thus, the refractive index nb is 4 or less, and further preferably 3.6 or less. From the same viewpoint, the equivalent refractive index of the optical waveguide is preferably 3.3 or less.

When using the grating element in the sensor, outgoing light needs to have a light spot shape exhibiting the Gaussian distribution, and the transverse mode desirably becomes the fundamental mode. Thus, the optical waveguide of the grating device is preferably the fundamental mode waveguide not to excite the multi-mode by the laser light.

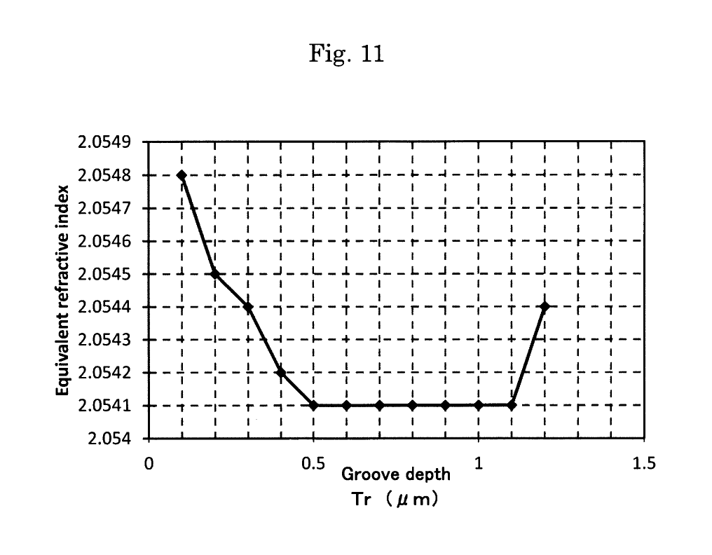

FIG. 11 is the results of calculation of the effective refractive indexes (equivalent refractive indexes) in the transverse mode, i.e., fundamental mode of the optical waveguide at a wavelength of 800 nm when changing a groove depth Tr from 0.1 μm to 1.2 μm while the optical material layer is made of Ta₂O₅ and has a refractive index of 2.08, a thickness Ts=1.2 μm, and a ridge width Wm=3 μm.

From the results, when Tr is in a range of 0.1 to 0.4 μm, the light leaks out to the substrate and propagates in the substrate mode. On the other hand, when Tr is in a range of 0.5 to 1.1 μm, the effective refractive index does not change, and the light propagates in the ridge waveguide mode. However, when Tr is 1.2 μm, which means the groove is completely cut to the bottom, it is found that the effective refractive index increases to strengthen the trapping of light.

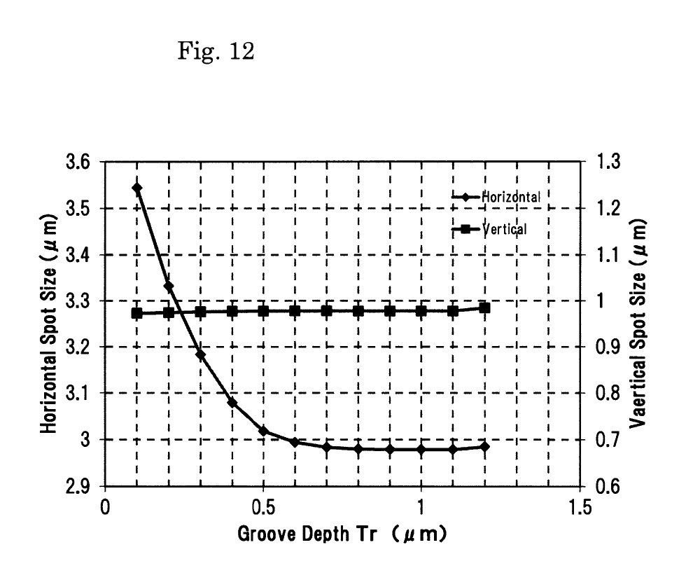

FIG. 12 shows the results of calculation of spot sizes in the horizontal direction and the vertical direction, respectively, in the fundamental mode of the optical waveguide calculated as shown in FIG. 11. As can be seen from the results, as Tr is increased, the spot size in the horizontal direction becomes smaller, thus strengthening the trapping of the light. Thereafter, while Tr changes from 0.5 μm to 1.2 μm indicative of the completely cut groove, the spot shape in the horizontal direction hardly changes. On the other hand, the spot size in the vertical direction does not depend on Tr, and is almost a constant value.

For the sensors, to efficiently excite the fundamental mode of the grating device with the laser light, the light spot shape of the grating device is preferably larger than the spot shape of the laser light, and also the thickness of the optical material layer is preferably 0.5 μm or more. The increase in thickness of the optical material layer makes it difficult to suppress the influence of the multi-mode. From this perspective, the thickness of the optical material layer is preferably 3 μm or less and more preferably 2.5 μm or less.

From the viewpoint described above, it can be confirmed that the groove depth Tr is standardized by the thickness Tₛ of the optical material layer even when changing the material of the optical material layer. That is, Tᵣ/Tₛ is preferably 0.4 or more, and preferably 0.9 or less.

When using the grating element in the sensor, as mentioned above, the transverse mode and fundamental mode is preferable. However, to improve the efficiency of coupling the laser light with the waveguide, the thickness of the optical material layer is preferably 0.5 μm or more, and thus the waveguide tends to be brought into the multi-mode.

When the optical waveguide is in the transverse mode and multi-mode, a plurality of grating reflection wavelengths are set corresponding to the effective refractive indexes of the respective waveguide modes. Thus, the laser excitation corresponding to the multi-mode possibly occurs. However, if a difference in effective refractive index between the fundamental mode and the high-order mode is increased to enable the reflection wavelength in the high-order mode to shift to the outside of the laser emission wavelength of the laser as the light source, the light in the fundamental mode can be used for sensing without being excited. From this viewpoint, the difference in reflection wavelength between the fundamental mode and the high-order mode is preferably 2.5 nm or more, and more preferably 3 nm or more.

When using the semiconductor laser as a light source 2, a gain range of the laser is so small and the range of the laser emission wavelengths is so narrow that the light in the fundamental mode can be obtained more easily.

The grating device can weaken the confinement of light in the optical waveguide formed by a pair of ridge grooves, thus making it less likely to cause the transverse mode and multi-mode. Even if the multi-mode occurs, a difference in refractive index from the fundamental mode can be increased to suppress the excitation of the multi-mode. In this regard, the lower limit of Tᵣ/Tₛ is preferably 0.4 or more, and more preferably 0.55. The upper limit of Tᵣ/Tₛ is preferably 0.9 or less, and more preferably 0.75 or less.

Table 1 shows the characteristics of αn and αΛ of various materials. As a result, it is found that the reflective optical sensor device can possess the higher sensitivity, compared to the conventional FBG. For the strain sensor to which the reflective optical sensor device of the invention is applied, variation in refractive index due to the stress can possess the higher sensitivity than the conventional FBG.

TABLE 1

| | n | $\frac{\partial n}{\partial T} \cdot \frac{1}{n}$ | α_{Λ} | $\frac{\partial {λ}_{G}}{\partial T}$ |
|---|---|---|---|---|
| FBG | 1.49 | 9 × 10⁻⁶ | 3 | 0.01 |
| GaAs | 3.62 | 1.1 × 10⁻⁴ | 6.9 | 0.08 |
| zLN | 2.17 | 1.4 × 10⁻⁴ | 5 | 0.1 |
| xLN | 2.25 | 4.4 × 10⁻⁵ | 16 | 0.05 |
| Units | — | — | ppm/° C. | nm/° C. |

In the reflective optical sensor device of the invention, a full width Δλ_{G} at half maximum of the peak of the Bragg reflectivity is not less than 0.8 nm nor more than 6.0 nm. To easily identify the Bragg reflection wavelength, the full width Δλ_{G} at half maximum is preferably wide. For this reason, the full width Δλ_{G} at half maximum is made 0.8 nm or more, and preferably 1.5 nm or more. An excessively wide full width at half maximum can make the reflectivity at the peak flat, making it difficult to identify the reflection wavelength. From this viewpoint, the full width at half maximum Δλ_{G} is set to 6 nm or less, and preferably 4 nm or less.

Note that λ_{G} is the Bragg wavelength. That is, when the lateral axis indicates the reflection wavelength due to the Bragg grating, and the longitudinal axis indicates the reflectivity, the wavelength at which the reflectivity is maximized is referred to as the “Bragg wavelength”. The full width Δλ_{G} at half maximum is the difference between two wavelengths at which its reflectivity is equal to a half of its maximum reflectivity at the peak with the Bragg wavelength positioned at the center.

In the invention, the depth td of each of the convexes and concaves forming the Bragg grating is not less than 20 nm nor more than 250 nm. To improve the reliability of sensing by increasing the reflectivity in the Bragg reflection, the depth td of the convexes and concaves is 20 nm or more, and more preferably 30 nm or more. To reduce the propagation loss of the light, the depth td is 250 nm or less, and more preferably 200 nm or less. As the depth of the grating is increased, the higher reflectivity can be obtained even though the grating length is short.

In the reflective optical sensor device of the invention, for example, the reflected light can be sensed at its reflectivity having at least 3%. Thus, the grating length is preferably set to 10 μm or more. When the grating length exceeds 1000 μm, the reflectivity becomes 100% or higher. Thus, the grating length does not need to be longer than 1000 μm because it can increase the loss of light in the grating. Thus, the grating length is preferably set at 1000 μm or less. In terms of miniaturization, the grating length is more preferably 300 μm or less. To set the full width at half maximum at 6 nm or less, the grating length is much more preferably 200 μm or less.

The ridge optical waveguide can be physically processed and formed, for example, by a cutting process with a peripheral cutting edge, a laser ablation process, and the like.

The Bragg grating can be formed physically or chemically by etching in the following way.

Specifically, a metal film made of Ni, Ti, etc., is deposited on the optical material layer, and windows are formed periodically by photolithography, thereby forming an etching mask. Then, periodic grating-grooves are formed by a dry etching device for reactive ion etching and the like. Finally, the metal mask is removed, whereby the Bragg grating can be formed.

To further improve the optical damage resistance of the optical waveguide, the optical material layer may contain one or more kinds of metal elements selected from the group consisting of magnesium (Mg), zinc (Zn), scandium (Sc), and indium (In). In this case, magnesium is particularly preferable. Crystals of the optical material layer can contain rare-earth elements as doped elements. Suitable rare-earth elements include, particularly, Nd, Er, Tm, Ho, Dy, and Pr.

Material for the adhesive layer may be an inorganic adhesive, an organic adhesive, or a combination of the inorganic adhesive and the organic adhesive.

The optical material layer 11 may be deposited and formed over a support base by a thin-film formation method. Suitable thin-film formation methods can include sputtering, vapor deposition, and CVD. In this case, the optical material layer 11 is formed directly on the support base, which does not need the above-mentioned adhesive layer.

Materials for such a support base are not specifically limited, but can include, for example, glass, such as lithium niobate, lithium tantalate and fused quartz, crystal, Si, sapphire, aluminum nitride, and SiC.

The reflectivity of the non-reflective layer needs to be lower than the grating reflectivity. Materials suitable for use in deposition over the non-reflective layer can include a laminated film made of oxides, such as silicon dioxide and tantalum pentoxide, metals and the like.

Each end surface of the grating element may be obliquely cut to suppress the reflection at the end surface. Bonding between the grating device and the support substrate is fixed with the adhesive in the example shown in FIG. 3, but may be direct bonding.

In a preferred embodiment, in terms of improving the sensitivity, the reflectivity of the reflective optical sensor device is preferably set at not less than 3% nor more than 40%. The reflectivity is more preferably 5% or more, and more preferably 25% or less.

In a preferred embodiment, a length Lm of the propagating portion is set at 100 μm or less (see FIG. 1). To shorten the length of an external resonator, the length Lm of the propagating portion is preferably 40 μm or less. Thus, the stable oscillation is promoted. The lower limit of the length Lm of the propagating portion is not specifically limited, but preferably 10 μm or more, and more preferably 20 μm or more.

### EXAMPLES

### Example 1

The device shown in FIGS. 1 to 3 were fabricated in the following way.

Specifically, Ta₂O₅ was deposited in a thickness of 1.2 μm on a quartz substrate of each sample by the use of a sputtering device to form a waveguide layer. Then, Ti was deposited on the Ta₂O₅ layer, followed by forming a grating pattern in the y-axis direction by the photolithography technique. Subsequently, grating-grooves were formed in the respective samples in lengths Lb 5 to 100 μm, 300 μm, 500 μm, and 1000 μm at a pitch interval A of 232 nm by the fluorine-based reactive ion etching using the Ti pattern as a mask. For each of the grating-grooves with these lengths, grating-groove depths were set to 20, 40, 60, 100, 160, 200, and 350 nm. Further, to form the optical waveguide for propagation of the light in the y-axis direction, grooves were formed to have a width Wm of 3 μm and Tr of 0.5 μm by the reactive ion etching in the same way as that described above.

Thereafter, the substrate in each sample was cut in a bar shape by a dicing device, and both end surfaces of each bar were optically polished. Then, 0.1% AR coating was formed over both end surfaces. Finally, chip cutting was performed to fabricate reflective optical sensor devices. The element size was set to have 1 mm width and 500 μm length Lwg.

Regarding the optical characteristics of the grating element, the reflection characteristics in each sample were evaluated from the transmission characteristics by inputting the light in the TE mode into the grating element using a superluminescent diode (SLD), which was a broadband wavelength light source, followed by analyzing the outgoing light therefrom by an optical spectrum analyzer. All the central reflection wavelengths measured in this way were 945±1 nm.

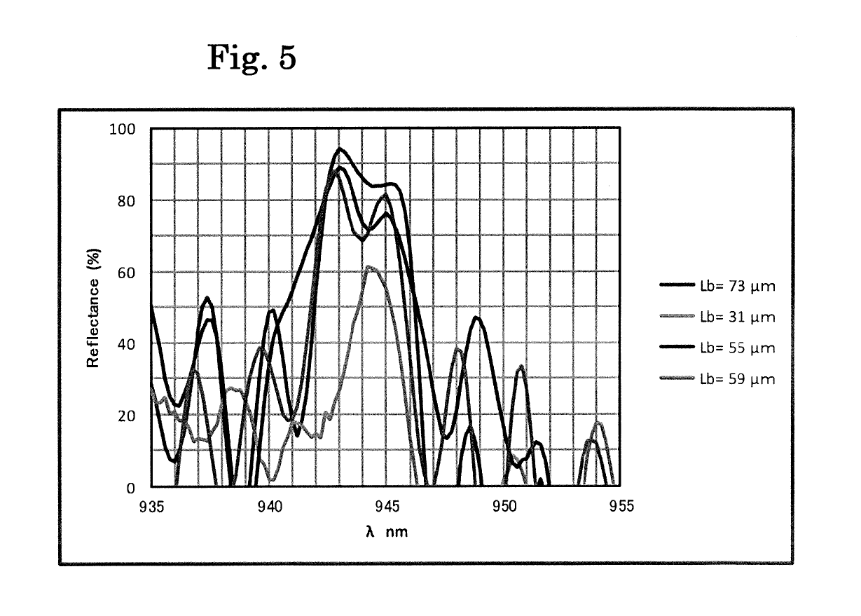

FIG. 5 shows the results of the reflection characteristics in the groove depth of 200 nm in the grating length ranging from 30 μm to 70 μm. As can be seen from the results, as the grating length is shortened, the reflectivity becomes lower.

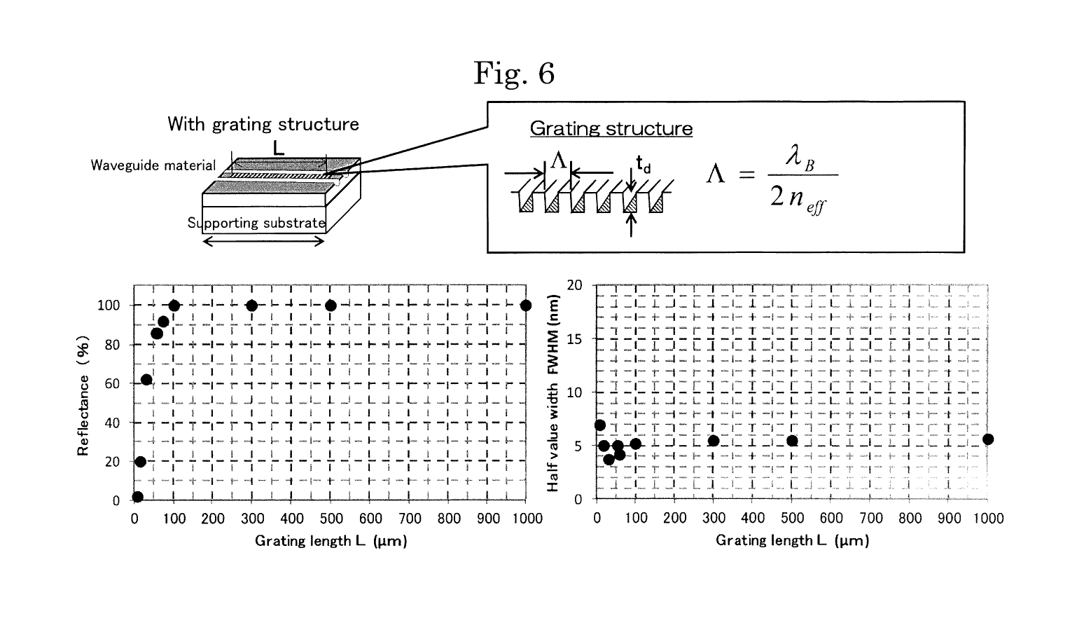

FIG. 6 shows the results of the reflectivity and the reflection full width at half maximum for each of the grating lengths of 10 μm to 1000 μm. As can be seen from the results, for the grating length of 9 μm, the reflectivity was 2%, and the full-width at half maximum was 7 nm, whereas for the grating length of 10 μm or more (17 μm), the reflectivity was 3% or more (20%), and the full width at half maximum was 6 nm or less (5 nm).

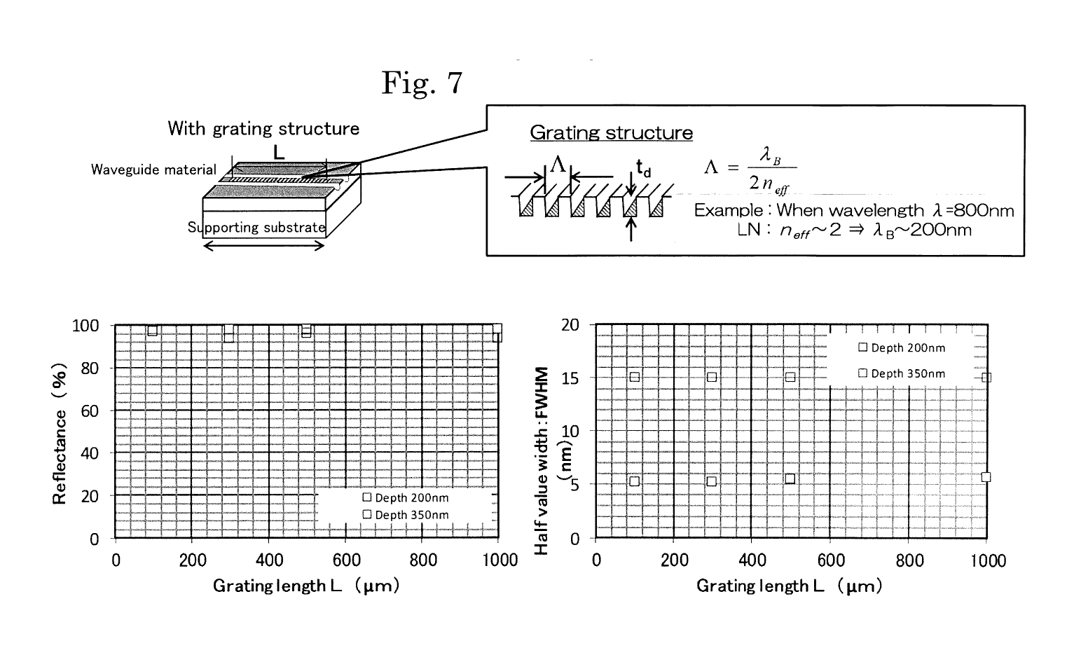

FIG. 7 shows the results of the reflectivity and the full width at half maximum at the grating length of 100 μm or more in each of the grating-groove depths of 200 nm and 350 nm. As can be seen from the results, for these depths and lengths, the reflectances took 100%, and the full widths at half maximum took the certain value.

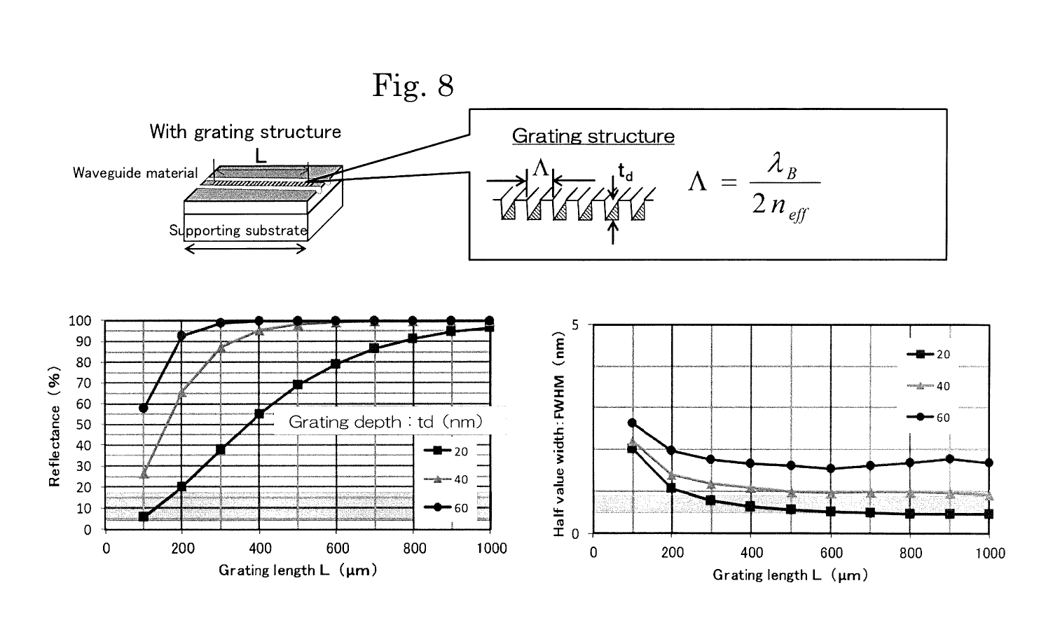

FIG. 8 shows the results of the reflectivity and the full width at half maximum at the grating lengths of 50 to 1000 μm in each of the grating-groove depths of 20, 40, and 60 nm. In the range of these groove depths, it is found that the reflectivity can be controlled significantly by the grating length. The full width at half maximum tends to monotonically increase in the grating length of 400 μm or less. In the grating depth of 20 nm, when the grating length was 200 μm or more, the full width at half maximum became less than 0.8 nm.

### Example 2

Then, Ti was deposited on a lithium niobate crystal substrate which was a z-cut plate doped with MgO, followed by forming a grating pattern in the y-axis direction by the photolithography technique. Subsequently, grating-grooves were formed at a pitch interval Λ of 214 nm to have a length Lb of 100 μm by the fluorine reactive ion etching using the Ti pattern as a mask. The grating-groove depths were set to 20, 40, and 60 nm in the respective samples. To form the optical waveguide for propagation in the y-axis direction, the grooves with 3 μm in width Wm and 0.5 μm in Tr were formed in a grating portion of each sample by an excimer laser. Further, a buffer layer 17 made of SiO₂ was deposited in a thickness of 0.5 μm at the groove formation surface by the sputtering device. A black LN substrate was used as the support substrate and attached to the grating formation surface.

Then, the black LN substrate side was fixed to a surface plate for lapping, and fine polishing was performed from the side of the back surface of the LN substrate with the grating formed thereat into a thickness (Ts) of 1.2 μm. Thereafter, the substrate was removed from the surface plate for lapping, and a buffer layer 17 made of SiO₂ was deposited by sputtering in a thickness of 0.5 μm at the polished surface of the substrate.

Thereafter, the substrate in each sample was cut in a bar shape by a dicing device, and both end surfaces of each bar were optically polished. Then, 0.1% AR coating was formed over both end surfaces. Finally, chip cutting was performed to fabricate the grating elements shown in FIGS. 1 and 4. The element size was set to have 1 mm width and 500 μm length Lwg.

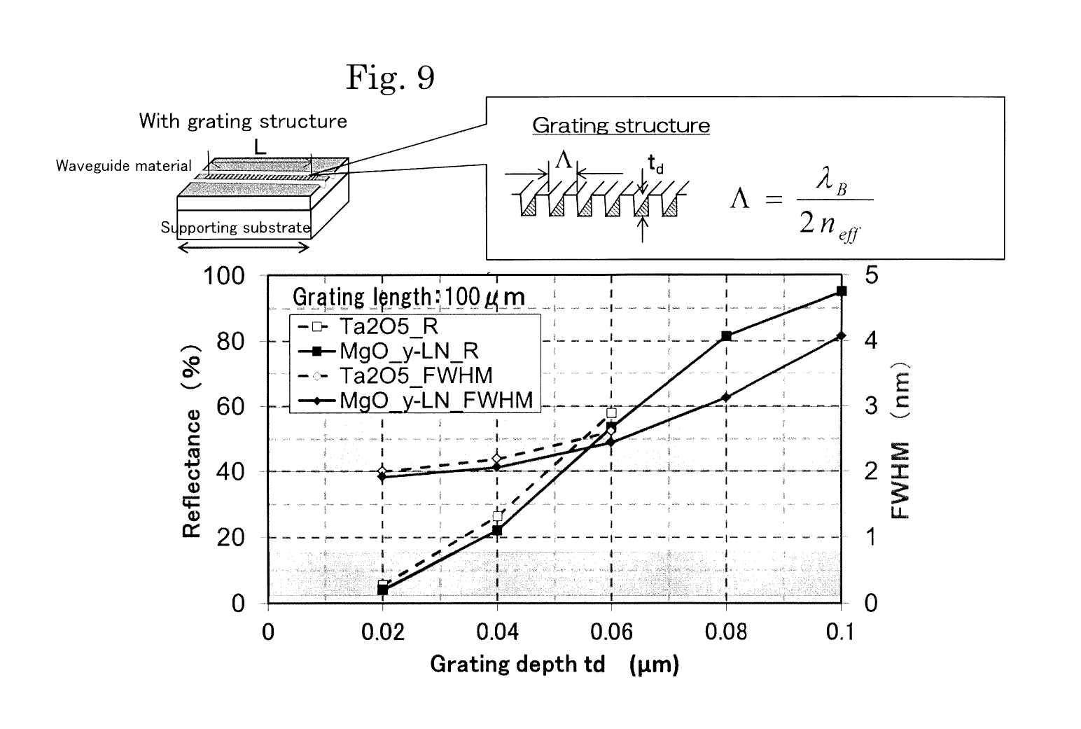

Regarding the optical characteristics of the grating device, the reflection characteristics in each sample were evaluated from the transmission characteristics by inputting the light in the TE mode into the grating device using a superluminescent diode (SLD), which was a broadband wavelength light source, followed by analyzing the outgoing light therefrom by an optical spectrum analyzer. The results are shown in FIG. 9.

As can be seen from these results, the reflection characteristics of LN were substantially the same as those of Ta₂O₅. In the TE mode, the central wavelength was 945 nm, the maximum reflectivity was 20%, and the full width at half maximum Λλ_{G} was 2 nm.

### Example 3

Ti was deposited on a lithium niobate crystal substrate which was a y-cut plate doped with MgO, followed by forming a grating pattern in the y-axis direction by the photolithography technique. Subsequently, grating-grooves were formed at a pitch interval A of 224 nm to have a length Lb of 100 μm by the fluorine reactive ion etching using the Ti pattern as a mask. The grating-groove depths were set to 20, 40, and 60 nm in the respective samples. To form the optical waveguide for propagation in the x-axis direction, grooves with 3 μm in width Wm and 0.5 μm in Tr were formed in a grating portion of each sample by the excimer laser. Further, a buffer layer 16 made of SiO₂ was deposited in a thickness of 0.5 μm at the groove formation surface by the sputtering device. A black LN substrate was used as the support substrate and attached to the grating formation surface.

Then, the black LN substrate side was fixed to the surface plate for lapping, and fine polishing was performed from the side of the back surface of the LN substrate with the grating formed thereat into a thickness (Ts) of 1.2 μm. Thereafter, the substrate was removed from the surface plate for lapping, and a buffer layer 17 made of SiO₂ was deposited in a thickness of 0.5 μm at the polished surface of the substrate by sputtering.

Thereafter, the substrate in each sample was cut in a bar shape by the dicing device, and both end surfaces of each bar were optically polished. Then, 0.1% AR coating was formed over both end surfaces. Finally, chip cutting was performed to fabricate grating elements. The element size was set to have 1 mm width and 500 μm length Lwg.

Regarding the optical characteristics of the grating device, the reflection characteristics in each sample were evaluated from the transmission characteristics by inputting the light in the TE mode into the grating device using the superluminescent diode (SLD), which was a broadband wavelength light source, followed by analyzing the outgoing light therefrom by an optical spectrum analyzer.

As can be seen from the results, the reflectivity and full width at half maximum of this example were the same as those of the device in Example 2. It is found that LN and Ta₂O₅ showed substantially the same reflectivity and full width at half maximum. At this time, in the TE mode, the central wavelength was 945 nm, the maximum reflectivity was 20%, and the full width at half maximum Δλ_{G} was 2 nm.

It has been found that, even though the wavelength of the light changes in a wavelength range from 600 nm to 1.55 μm, the substantially same reflectivity and full width at half maximum can be obtained.

1. A reflective optical sensor device comprising:
a support substrate;
an optical material layer disposed over said support substrate, said optical material layer having a thickness of 0.5 μm or larger and 3.0 μm or smaller;
a ridge optical waveguide having an incident face to which a light from a semiconductor laser is incident and an emitting face for emitting an emission light with a desired wavelength;
a Bragg grating comprising convexes and concaves formed within said ridge optical waveguide; and
a propagating portion disposed between said incident face and said Bragg grating,
wherein said reflective optical sensor device satisfies relationships represented by formulas (1), (2) and (3) below.
0.8 nm≦Δλ_{G}≦S6.0 nm (1)
20 nm≦td≦250 nm (2)
nb≧1.8 (3)
(Δλ_{G} in the formula (1) represents a full width at half maximum of a peak of a Bragg reflectivity;
td in the formula (2) represents a depth of convexes and concaves forming the Bragg grating; and
nb in the formula (3) represents a refractive index of a material forming said Bragg grating.)

2. The device of claim 1, wherein said ridge optical waveguide is formed by a pair of ridge grooves in said optical material layer.

3. The device of claim 2, wherein a ratio (Tᵣ/Tₛ) of a depth Tᵣ of said ridge groove to a thickness Tₛ of said optical material layer is 0.4 or more and 0.9 or less.

4. The device of claim 1, wherein said reflective optical sensor device satisfies a relationship represented by a formula (4) below:
10 μm≦Lb≦1000 μm (4)
(Lb in the formula (4) is a length of said Bragg grating.)

5. The device of claim 1, wherein said material forming said Bragg grating is selected from the group consisting of gallium arsenide, lithium niobate single crystal, lithium tantalate single crystal, tantalum oxide, zinc oxide, niobium oxide, indium phosphide and aluminum oxide.

6. The reflective optical sensor device of claim 1, wherein a transverse mode of said ridge optical waveguide comprises a multi mode, and wherein, in the case that a reflective optical sensor is configured, said sensor emitting a light whose transverse mode is of a fundamental mode.
